(19) United States
(12) Patent Application Publication
(10) Pub. No.: US 2002/0037723 A1
(43) Pub. Date: Mar. 28, 2002

(54) Refreshing service profile information using third-party SIP register messages

(76) Inventor: Adam Roach, Dallas, TX (US)

Correspondence Address: Ronald L. Grudziecki, BURNS, DOANE, SWECKER & MATHIS, L.L.P., P.O. Box 1404, Alexandria, VA, 22313-1404, US

(21) Appl. No.: 09/876,916

(22) Filed: Jun. 8, 2001

Related U.S. Application Data
(60) Provisional application No. 60/210,530, filed on Jun. 8, 2000.

(51) Int. Cl. H04Q 7/20

(52) U.S. Cl. 455/435

(57) ABSTRACT

A method of updating a user's service profile information in a home domain of a packet data network using Session Initiation Protocol (SIP) includes updating an established user's service profile record in a call instance host associated with a user's terminal by retrieving the user's service profile information from a home subscriber server (HSS) of the home domain. The updating is initiated by a REGISTER message, which contains sufficient information to identify the user's service profile, sent by a node in the system aware of a user profile change, such as the HSS or an operation and maintenance system, to the associated call instance host.

### CROSS-REFERENCE TO RELATED APPLICATION

This application is related to, and claims priority from, U.S. Provisional Application No. 60/210,530 entitled “Refreshing of Service Profile Information Using Third-Party SIP (Session Initiation Protocol) Register Messages” filed on Jun. 8, 2000, the disclosure of which is incorporated herein by reference.

### BACKGROUND

The present invention is related to a network communications, and more particularly to service information updates between network nodes.

The Internet Engineering Task Force (IETF) is a large open international community of network designers, operators, vendors, and researchers concerned with the evolution of the Internet architecture and the smooth operation of the Internet. The actual technical work of the IETF is done in its working groups, which are organized by topic into several areas (e.g., routing, transport, security, etc.). The IETF is primarily responsible for creating and updating protocols relating to the Internet. See http://www.ietf.org. One such protocol is the Session Initiation Protocol (SIP), defined in RFC 2543, which is incorporated herein by reference.

The 3GPP (Third Generation Partnership Project) standards body is a partnership of standards organizations and other related bodies cooperating in the production of globally applicable Technical Specifications and Technical Reports for a 3rd Generation Mobile System based on evolved Global System for Mobile communication (GSM) core networks and the radio access technologies that they support (i.e., Universal Terrestrial Radio Access (UTRA) both Frequency Division Duplex (FDD) and Time Division Duplex (TDD) modes). The Partners have further agreed to co-operate in the maintenance and development of the GSM Technical Specifications and Technical Reports including evolved radio access technologies (e.g., General Packet Radio Service (GPRS) and Enhanced Data rates for GSM Evolution (EDGE)). See hftp://www.3gpp.org.

The 3GPP (Third Generation Partnership Project) standards body employs a variety of protocols defined by the IETF, including SIP. The SIP is an application-layer control (signaling) protocol for creating, modifying and terminating sessions with one or more participants. These sessions include Internet multimedia conferences, Internet telephone calls and multimedia distribution. Members in a session can communicate via multicast or via a mesh of unicast relations, or a combination of these. SIP invitations used to create sessions carry session descriptions which allow participants to agree on a set of compatible media types. SIP supports user mobility by proxying and redirecting requests to the user's current location. Users can register their current location. SIP is not tied to any particular conference control protocol. SIP is designed to be independent of the lower-layer transport protocol and can be extended with additional capabilities.

SIP is based on the request-response paradigm. To initiate a session, the caller (known as the User Agent CIient, or UAC ) sends a request (called an INVITE), addressed to the person the caller wants to talk to. The request is not sent directly to the called party, but rather to a proxy server responsible for routing and delivering messages to the called party. The called party then sends a response, accepting or rejecting the invitation, which is forwarded back through the same set of proxies, in reverse order.

A proxy can receive a single INVITE request, and send out more than one INVITE request to different addresses. This feature, called “forking,” allows a session initiation attempt to reach multiple locations, in the hopes of finding the desired user at one of them.

The proxy server consults a registration database, and forwards the INVITE to the called party. The INVITE then reaches the called party, who can then respond to it. SIP provides many responses, including acceptance, rejection, redirection, busy, etc. The response is forwarded back through the proxies to the original caller. An acknowledgment request (ACK) is sent and a session is established. Media can then flow between the parties.

SIP is patterned after HTTP (Hypertext Transfer Protocol) in many ways. HTTP is also request-response. SIP borrows much of the syntax and semantics from HTTP. The textual message formatting, usage of headers, MIME support, and many headers are identical.

SIP defines another request, called REGISTER, which is used to inform a proxy of an address binding. This allows the proxy to know that a party is at a specific host on the network. The bindings registered through SIP are periodically refreshed, and are eventually removed.

The REGISTER request-header field is defined in Table 1. The “address-of-record” is the SIP address that the registry knows, typically of the form “user@domain” rather than “user@host”. In third-party registration, the entity issuing the request is different from the entity being registered.

TABLE 1

| | |
|---|---|
| To | The To header field contains the address-of-record whose |
| | registration is to be created or updated. |
| From | The From header field contains the address-of-record of the |
| | person responsible for the registration. For first-party |
| | registration, it is identical to the To header field value. |
| Request- | The Request-URI (Universal Resource Identifier) names the |
| URI | destination of the registration request, i.e., the domain of the |
| | registrar. The user name MUST be empty. Generally, the |
| | domains in the Request-URI and the To header field have the |
| | same value; however, it is possible to register as a “visitor”, |
| | while maintaining one's name. For example, a traveler |
| | sip:alice@acme.com (To) might register under the Request- |
| | URI sip:atlanta.hiayh.org, with the former as the To header |
| | field and the latter as the Request-URI. The REGISTER |
| | request is no longer forwarded once it has reached the server |
| | whose authoritative domain is the one listed in the |
| | Request-URI. |
| Call-ID | All registrations from a client SHOULD use the same Call-ID |
| | header value, at least within the same reboot cycle. |
| Cseq | Registrations with the same Call-ID MUST have increasing |
| | CSeq header values. However, the server does not reject |
| | out-of-order requests. |
| Contact | The request MAY contain a Contact header field; future |
| | non-REGISTER requests for the URI given in the To header |
| | field SHOULD be directed to the address(es) given in the |
| | Contact header. |

An example of a registration procedure may be as follows. A user at host saturn.bell-tel.com registers on start-up, via multicast, with the local SIP server (proxy) named bell-tel.com. In the example, the user agent on saturn expects to receive SIP requests on UDP port 3890. The message is:

C->S: REGISTER sip:bell-tel.com SIP/2.0

Via: SIP/2.0/UDP saturn.bell-tel.com

From: sip:watson@bell-tel.com

To: sip:watson@bell-tel.com

Call-ID: 70710@saturn.bell-tel.com

CSeq: 1 REGISTER

Contact: <sip:watson@saturn.bell-tel.com:3890;tranisport=udp>

Expires: 7200

The registration expires after two hours (7,200 seconds). Any future invitations for watson@bell-tel.com arriving at sip.bell-tel.com will now be redirected to watson@saturn.bell-tel.com, UDP port 3890.

If Watson wants to be reached elsewhere, such as on ari on-line service he uses while traveling, he updates his reservation after first cancelling any existing locations:

C->S: REGISTER sip:bell-tel.com SIP/2.0

Via: SIP/2.0/UDP saturn.bell-tel.com

From: sip:watson@bell-tel.com

To: sip:watson@bell-tel.com

Call-ID: 70710@saturn.bell-tel.com

CSeq: 2 REGISTER

Contact: *

Expires: 0

C->S: REGISTER sip:bell-tel.com SIP/2.0

Via: SIP/2.0/UDP saturn.bell-tel.com

From: sip:watson@bell-tel.com

To: sip:watson@bell-tel.com

Call-ID: 70710@saturn.bell-tel.com

CSeq: 3 REGISTER

Contact: sip:tawatson@example.com

Now, the server will forward any request for Watson to the server at example.com, using the Request-URI tawatson@example.com. For the server at example.com to reach Watson, he will need to send a REGISTER there, or inform the server of his current location through some other means.

It is possible to use third-party registration. Here, the secretary jon.diligent registers his boss, T. Watson:

C->S: REGISTER sip:bell-tel.com SIP/2.0

Via: SIP/2.0/UDP pluto.bell-tel.com

From: sip:jon.diligent@bell-tel.com

To: sip:watson@bell-tel.com

Call-ID: 17320@pluto.bell-tel.com

CSeq: 1 REGISTER

Contact: sip:tawatson@example.com

The request could be sent to either the registrar at bell-tel.com or the server at example.com. In the latter case, the server at example.com would proxy the request to the address indicated in the Request-URI. Then, the Max-Forwards header could be used to restrict the registration to that server.

A more complex example of registration involves the registration of a mobile terminal (handset) communicating via a visited domain (away from the home domain), as illustrated in FIG. 1. The handset performs a registration request on a proxy in a visited domain to allow calls to be successfully routed to and from it (1). There are typically many intermediate network elements in the visited domain to provide ultimate access to the visited proxy. For example, the handset must communicate via a radio access network, such as a GPRS (General Packet Radio Service) network. The radio access network communicates via a serving GPRS support node (SGSN) and a gateway GPRS support node (GGSN), both supporting the visited domain. In this example, the handset is requesting a registration of four hours (14400 seconds).

REGISTER sip:home-domain.com SIP/2.0

To: <sip:user@home-domain.com>

From: <sip:user@home-domain.com>;tag=0000-1111

Call-ID: 8888@handset1234.visited-domain.com

CSeq: 99 REGISTER

Contact: sip:user@[5555::1234]

Expires: 14400

The visited proxy forms an association between the IP address of the phone as expressed in the Contact header (5555::1234) and the URI of the home proxy for that phone. The visited proxy may adjust the duration of the registration to be a shorter value. In this example, the visited network has a policy that registrations can be for no longer than 2 hours (7200 seconds). After adjusting the Contact header to point to itself and adjusting the Expires header to meet local policy, the visited proxy proxies the registration message to the home Interrogating Gateway node (IGW) (2). In 3GGP specifications, the IGW is referred to as the l-CSCF (Interrogating Call/Session Control Function). The IGW is responsible for querying a Location Server (LS), which is a functional area of a Home Subscriber Server (HSS), and acting on the returned information. The LS is the functional part of the HSS that maintains the location of the user's Serving Call Instance (CI) host. The LS is accessed using SIP REGISTER and INVITE messages, and serves the roles described as “location server” and “registrar” in RFC2543. The CI host is responsible for execution of services, maintaining a call instance for the duration of a user's registration in a particular domain. In 3GGP specifications, the CI host is referred to as the S-CSCF (Serving Call/Session Control Function).

REGISTER sip:home-domain.com SIP/2.0

To: <sip:user@home-domain.com>

From: <sip:user@home-domain.com>;tag=0000-1111

Call-ID: 8888@handset1234.visited-domain.com

CSeq: 99 REGISTER

Contact: sip:user@proxy.visited-domain.com

Expires: 7200

The home IGW proxies the registration to the HSS, which contains information relating to the registration state of the subscriber and the address of a call instance host (3). The CI host is the host for the execution of the call states. The CI host downloads the subscriber profile and tracks the users location during the call.

REGISTER sip:hss.home-domain.com SIP/2.0

To: <sip:user@home-domain.com>

From: <sip:user@home-domain.com>;tag=0000-1111

Call-ID: 8888@handset1234.visited-domain.com

CSeq: 99 REGISTER

Contact: sip:user@proxy.visited-domain.com

Expires: 7200

The HSS selects a CI host for the user and redirects the IGW to the CI host (4).

SIP/2.0 302 Redirect

To: <sip:user@home-domain.com>;tag=5555-1212

From: <sip:user@home-domain.com>;tag=0000-1111

Call-ID: 8888@handset1234.visited-domain.com

Contact: sip:ci.home-domain.com

CSeq: 99 REGISTER

The IGW resends the REGISTER message to the machine indicated in the Contact header, which is the CI host (5).

REGISTER sip:ci.home-domain.com SIP/2.0

To: <sip:user@home-domain.com>

From: <sip:user@home-domain.com>;tag=0000-1111

Call-ID: 8888@-handset1234.visited-domain.com

CSeq: 99 REGISTER

Contact: sip:user@proxy.visited-domain.com

Expires: 7200

The CI host will create a local record of where it should forward messages intended for the user, derived from the Contact header. Since this is an initial registration (i.e., no call instance already exists), the CI host will also create a call instance record and, if appropriate, download subscriber information.

In this example, the home network has a policy that registrations may be for no longer than 30 minutes (1800 seconds). The CI host adjusts the Expires header accordingly, and generates a response (6).

SIP/2.0 200 OK

To: <sip:user@home-domain.com>;tag=AMA-5309

From: <sip:user@home-domain.com>;tag=0000-1111

Call-ID: 8888@handset1234.visited-domain.com

CSeq: 99 REGISTER

Expires: 1800

The home domain Incoming Call Gateway forwards the response using normal SIP response handling rules (7).

The visited domain proxy takes note of the final registration duration and updates its correlation record for this handset with the expiration time for this registration. This allows the visited domain to discard registrations once they have expired. The response is then forwarded back to the handset per normal SIP response handling rules (8).

The above procedures outline the SIP message flows for caller registration in a home-only service execution context. There is no procedure for updating service profile information (either service parameters or triggers) between two nodes interconnected by an IP (Internet Protocol) network using existing IETF protocols after initial registration has been performed.

The current methods for updating service information are all based on legacy telephony systems. As a consequence, they do not work well in either a multimedia context, or with SIP. In particular, the CSI (Capability Set 1) protocol used within CAMEL (Call Management Language) is based on a set of triggers that largely do not exist in the SIP call model. Therefore, a method of transferring subscriber information to a SIP server providing services is not possible using current techniques. This capability is required for services in the 3GPP network.

Within the traditional wireless network, the HLR node (Home Location Register) uses MAP (Mobile Application Part) to contact the MSC (Mobile Switching Center) and transfer the information. MAP is not currently defined to run over IP networks, which are implemented for use with 3GPP mobile systems.

Accordingly, a procedure is needed to update service profile information between two nodes interconnected by an IP network using existing IETF protocols, such as SIP, after initial registration has been performed.

### SUMMARY

The present invention addresses these and other concerns by expanding on the SIP message flows in two important ways: a procedure is provided by which profile information may be transited from a central repository and message flows are presented for visited domain control of service execution. An application of the SIP third-party registration mechanism is used to cause a new download of service information into the service execution or triggering node, represented as the CI host. The use of this mechanism allows for a more flexible set of information to be transited to the CI host for executing or triggering services in a packet data network supporting multimedia information, such as an IP network, without involving the handset or the proxy server in the visited domain that the handset uses during registration.

According to one aspect, a method of updating a user's service profile information in a home domain of a packet data network using SIP includes updating an established user's service profile record in a call instance host associated with a user's terminal by retrieving the user's service profile information from a HSS of the home domain. The updating is initiated by a REGISTER message, which contains sufficient information to identify the user's service profile, sent by a node in the system aware of a user profile change, such as the HSS, to the associated call instance host.

According to another aspect, a method of updating a user's service profile information in a visited domain of a packet data network using SIP includes updating an established user's service profile record in a call instance host of the visited domain associated with a user's terminal by retrieving the user's service profile information from a HSS of the home domain. The updating is initiated by a REGISTER message, which contains sufficient information to identify the user's service profile, sent by a node in the system aware of a user profile change, such as the home domain HSS, to the associated visited domain call instance host.

In still another aspect, a system for updating a user's service profile information in a home domain in a packet data network using SIP, the system including a HSS and a call instance host. The system further includes logic that updates an established user's service profile record in the call instance host by retrieving the user's service profile information from the HSS. The updating is initiated by a REGISTER message, which contains sufficient information to identify the user's service profile, sent by a node in the system aware of a user profile change, such as the HSS, to the call instance host.

In yet another aspect, a system for updating a user's service profile information in a visited domain in a packet data network using SIP, said system including a home domain HSS, a visited domain HSS and a visited domain call instance host. The system further includes logic that updates an established user's service profile record in the visited domain call instance host by retrieving the user's service profile information from the home domain HSS. The updating is initiated by a REGISTER message, which contains sufficient information to identify the user's service profile, sent by a node in the system aware of a user profile change, such as the visited domain HSS, to the visited domain call instance host.

### BRIEF DESCRIPTION OF THE DRAWINGS

The above and other objects, features, and advantages of the present invention will become more apparent in light of the following detailed description in conjunction with the drawings, in which like reference numerals identify similar or identical elements, and in which:

FIG. 1 is a block diagram illustrating a conventional registration procedure in a packet data network for a handset communicating with the home domain via a visited domain;

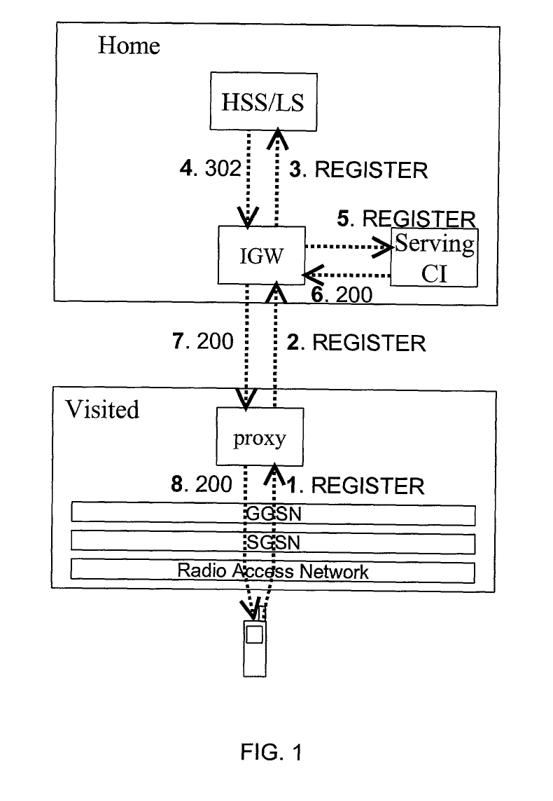

FIG. 2 is a block diagram illustrating a home domain execution registration and service profile transfer procedure in a packet data network for a handset communicating with the home domain via a visited domain according to an embodiment of the present invention;

FIG. 3 is a block diagram illustrating a visited domain execution registration and service profile transfer procedure in a packet data network for a handset communicating with the home domain via a visited domain according to an embodiment of the present invention;

FIG. 4 is a block diagram illustrating a home domain execution service profile update procedure in a packet data network for a handset communicating with the home domain via a visited domain according to an embodiment of the present invention; and

FIG. 5 is a block diagram illustrating a visited domain execution service profile update procedure in a packet data network for a handset communicating with the home domain via a visited domain according to an embodiment of the present invention.

### DETAILED DESCRIPTION

Preferred embodiments of the present invention are described below with reference to the accompanying drawings. In the following description, well-known functions and/or constructions are not described in detail to avoid obscuring the invention in unnecessary detail.

The message flows presented below provide solutions to a number of issues with registration and profile transfer while requiring only one minor protocol extension, which allows the transit of service information location in REGISTER requests and responses. Since the extension defined is minor and generally applicable to services within a wireless context and other contexts as well, a relatively easy progression to a proposed standard within the IETF is possible.

Some additional care is exercised to provide that: the handling of registrations is consistent among all nodes (regardless of home or visited control), the behavior of all nodes conforms as closely as possible to the requirements and spirit of RFC2543 and related documents, and the handling of service profile transfer allows services to be ignorant of the context in which they are running, e.g., home or visited.

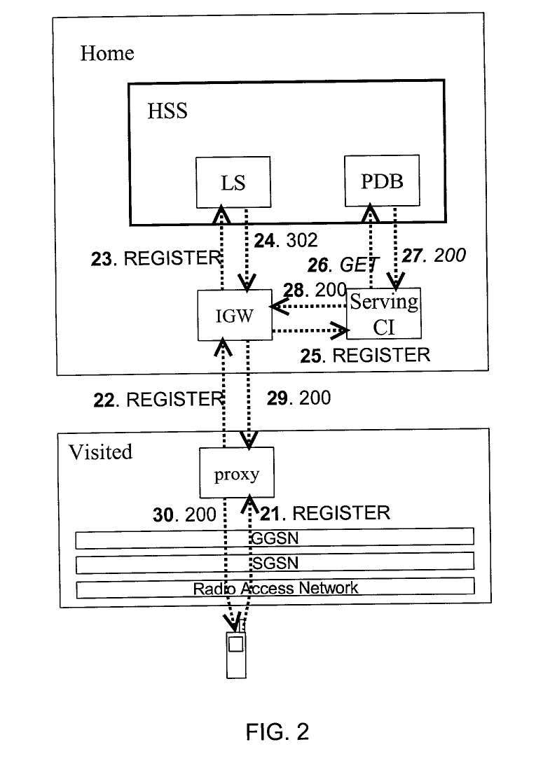

Turning again to the drawings, a home execution registration and service profile transfer is illustrated in FIG. 2. The handset performs a registration request to allow calls to be successfully routed to and from it (21). In this example, the handset is requesting a registration of four hours (14400 seconds).

REGISTER sip:home-domain.com SIP/2.0

To: <sip:user@home-domain.com>

From: <sip:user@home-domain.com>;tag=0000-1111

Call-ID: 8888@handset1234.visited-domain.com

CSeq: 99 REGISTER

Contact: sip:user@[5555::1234]

Expires: 14400

The visited proxy forms an association between the IP address of the phone as expressed in the Contact header (5555::1234) and the URI of the home proxy for that phone. The visited proxy may adjust the duration of the registration to be a shorter value. In this example, the visited network has a policy that registrations can be for no longer than 2 hours (7200 seconds). After adjusting the Contact header to point to itself and adjusting the Expires header to meet local policy, the visited proxy proxies the registration message to the home IGW (22). Here, the HSS may contact an external “CI Node Selection” function.

In the message, the proxy indicates the ability to support the extension “org.3gpp.service-transfer” using the service-transfer extension, indicated by underlining.

REGISTER sip:home-domain.com SIP/2.0

To: <sip:user@home-domain.com>

From: <sip:user@home-domain.com>;tag=0000-1111

Call-ID: 8888@handset1234.visited-domain.com

CSeq: 99 REGISTER

Contact: sip:user@proxy.visited-domain.com

Supported: org.3gpp.service-transfer

Expires: 7200

The home IGW proxies the registration to the HSS/LS (23).

REGISTER sip:hss.home-domain.com SIP/2.0

To: <sip:user@home-domain.com>

From: <sip:user@home-domain.com>;tag=0000-1111

Call-ID: 8888@handset1234.visited-domain.com

CSeq: 99 REGISTER

Contact: sip: user@proxy.visited-domain.com

Supported: org.3gpp.service-transfer

Expires: 7200

The HSS/LS selects a CI host for the user and redirects the IGW to the CI host (24). The HSS/LS also indicates the location from which the service profile should be retrieved. The service-transfer extension is changed from “supported” to “require.” The LS further inserts a “Service-Transfer-Location” header to indicate in which domain the service is to be executed.

SIP/2.0 302 Redirect

To: <sip:user@home-domain.com>;tag=5555-1212

From: <sip:user@home-domain.com>;tag=0000-1 111

Call-ID: 8888@handset1234.visited-domain.com

Contact: sip:ci.home-domain.com

CSeq: 99 REGISTER

Require: org.3gp.service-transfer

Service-Transfer-Location: home

Content-Type: text/uri-list

Content-length: 60

http://hss.home-domain.com/profiles/user%40home-domain.com

Based on the “Service-Transfer-Location” value of “home”, the IGW resends the REGISTER message to the machine indicated in the “Contact” header, which is the CI host (25).

REGISTER sip:ci.home-domain.com SIP/2.0

To: <sip:user@home-domain.com>

From: <sip:user@home-domain.com>;tag=0000-1111

Call-ID: 8888@handset1234.visited-domain.com

CSeq: 99 REGISTER

Contact: sip: user@proxy.visited-domain.com

Expires: 7200

Require: org.3gpp.service-transfer

Content-Type: text/uri-list

Content-Length: 60

http://hss. home-domain.com/profiles/user%40home-domain.com

The CI host will create a local record of where to forward messages intended for the user, derived from the Contact header. Since this is an initial registration (i.e., no call instance already exists), the CI host will also create a call instance record and, as necessary, download subscriber information.

The call instance record will be populated with information retrieved from the URL passed in the REGISTER message. To retrieve the information, a HTTP GET command is issued to access the user's service profile information stored in a Profile Database (PDB) within the HSS (26). The PDB is the repository for user service profile information.

GET /profiles/user%40home-domain.com HTTP/1.1

User-Agent: EriCSCF/1.0

Host: hss.home-domain.com

Connection: close

Accept: text/xml

The HSS replies with the user's service profile, expressed in XML (eXtensible Markup Language), for example (27). Note that the XML DTD (Document Type Definition) format shown here is merely exemplary, and not meant to define a definitive, or only, format. Two exemplary formats are shown: one for a service-oriented profile and another for a trigger-oriented profile.

HTTP/1.1 200 OK

Server: Stronghold/2.4.2 Apache/1.3.6 C2NetEU/2410 (Unix)

Content-Type: text/xml; charset=“utf-8”

Last-Modified: Tue, 30 May 2000 02:17:24 GMT

Date: Tue, 30 May 2000 12:38:21 GMT

<?xml version=“1.0” encoding=“utf-8”?>

<!DOCTYPE service-profile SYSTEM “3gsvcprof.dtd”>

<profile>

<service name=“call forward unconditional”>

<param name=“active”>false</param>

</service>

<service name=“call forward on busy”>

<param name=“active”>true</param>

<param name=“destination”>+1 9725830000</param>

</service>

</profile >

### (OR)

HTTP /1.1 200 OK

Server: Stronghold/2.4.2 Apache/1.3.6 C2NetEU /2410 (Unix)

Content-Type: text/xml;charset=“utf-8”

Last-Modified: Tue, 30 May 2000 02:17:24 GMT

Date: Tue, 30 May 2000 12:38:21 GMT

<?xml version=“1.0” encoding=“utf-8”?>

<!DOCTYPE trigger-profile SYSTEM “3gtrgprof.dtd”>

<profile>

<trigger method=“INVITE” type=request direction=sent >

<trigger method=“l NVITE” type=response from=100 to=199 direction=received />

<trigger method=“INVITE” type=response from=200 to=699 direction=sent />

<trigger method=“BYE” type=response from=200 to=699 direction=sent />

<trigger method=“BYE” type=response from=200 to=699 direction=received />

</profile>

In this example, the home network has a policy that registrations may be for no longer than 30 minutes (1800 seconds). The CI host adjusts the Expires header accordingly, and generates a response (28).

SIP/2.0:00 OK

To: <sip:user@home-domain.com>;tag=AAAA-5309

From: <sip:user@home-domain.com>;tag=0000-1111

Call- ID: 8888@handset1234.visited-domain.com

CSeq: 99 REGISTER

Expires: 1800

The home domain IGW forwards the response using normal SIP response handling rules (29).

The visited domain proxy takes note of the final registration duration and updates its correlation record for this handset with the expiration time for this registration. This allows the visited domain to discard registrations once they have expired. The response is then forwarded back to the handset using normal SIP response handling rules (30).

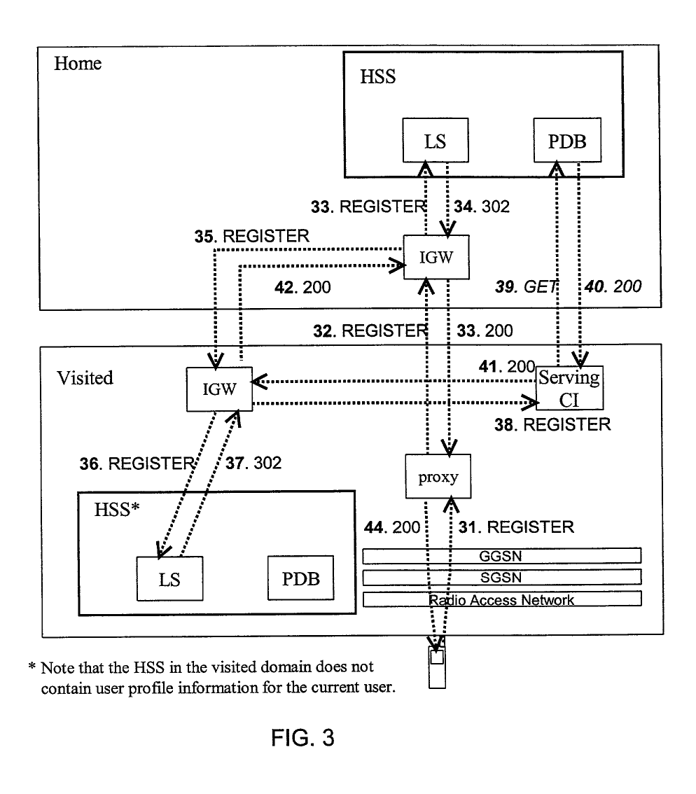

FIG. 3 illustrates a visited execution registration and profile transfer. The execution of this procedure is fundamentally the same as described above, with the primary difference being the nature of the response from the home domain location server. Instead of redirecting the IGW to a selected CI host in the home domain, it redirects to an IGW in the visited domain (35).

Using normal registration handling, the visited domain IGW then queries the visited HSS/LS (36) to determine which host to contact as the CI host. This information is returned in a SIP 302 response, which the CI host indicated in the “Contact” header (37). Based on this information, the IGW contacts the CI host (38). As described above, the CI host issues a HTTP GET to the URI passed in the SIP REGISTER request, which points to the user's service information (39) in the PDB. The service profile is then returned to the CI host (40), who then responds to the SIP register using normal response handling (steps 41 through 44).

A user agent must refresh its registration before the expiration of the period defined by the “Expires” header in the previous REGISTER response.

To avoid the unnecessary download of subscription information, the HTTP “HEAD” method may be employed to determine if the information the CI host has is current. The HEAD method is similar in function to the GET method, with the exception that no body is returned. The CI host can then compare the “Last-Modified” date against its internal date for the cached user's profile. If the profile information has been updated, a GET will be issued to retrieve the updated information. The subsequent GET will seldom be necessary during the course of normal REGISTER refreshing done by the terminal. However, a subsequent GET will almost always be triggered by a profile-refreshing REGISTER.

Note that HTTP/1.1 allows the GET request to use the same TCP (Transmission Control Protocol) connection as the original HEAD request, so the performance implications of making two requests for REGISTER updates is insignificant.

The messaging described above is related to the behavior exhibited by each node in the network, and driven by a desire for consistent operation regardless of the location of service control. The behaviors of each node are described below to illustrate this point. Note that no node exhibits differing behavior based on the model of service control (except for the LS, which actually makes the decision for home or visited control).

LS: Upon receipt of any type of SIP message, the LS checks to see if the user already has a location (i.e., Serving CI) registered. If not, the LS allocates a new location and returns a redirection response indicating the selected destination. This destination may be either a Serving CI in its own domain for home execution, or the host indicated for visited control transfer for visited execution. If the user is registered, the redirection indicates the same host as the response to the most recent registration. No call state is stored in the LS, only a registration state, which, in this case, consists of a binding between the user and either the Serving CI for home control or the IGW of the visited domain for visited control.

PDB: The PDB acts as a simple HTTP server. Returns profiles based on the HTTP URL in a HTTP GET or HEAD message.

IGW: Upon receipt of a SIP message, the IGW always contacts the LS (HSS) using that SIP message. The LS will respond with a redirection message, which the IGW will act upon by forwarding the original SIP message. No call or registration state needs to be stored in the IGW.

Proxy: At registration time, creates a record which binds the user to the domain in which the user's CI resides (based on the value of the “Service-Transfer-Host” header). Also provides emergency service intercept and location sensitive called number analysis. No call state is maintained in the proxy, only minimal registration state.

Serving CI: The serving CI, upon receipt of a SIP message, will check to see if a call instance exists for the appropriate user. If no call instance exists, one is created and profile information is downloaded from the host indicated in the registration message (the PDB). The other behaviors of a Serving CI are determined by the nature of the services being provided.

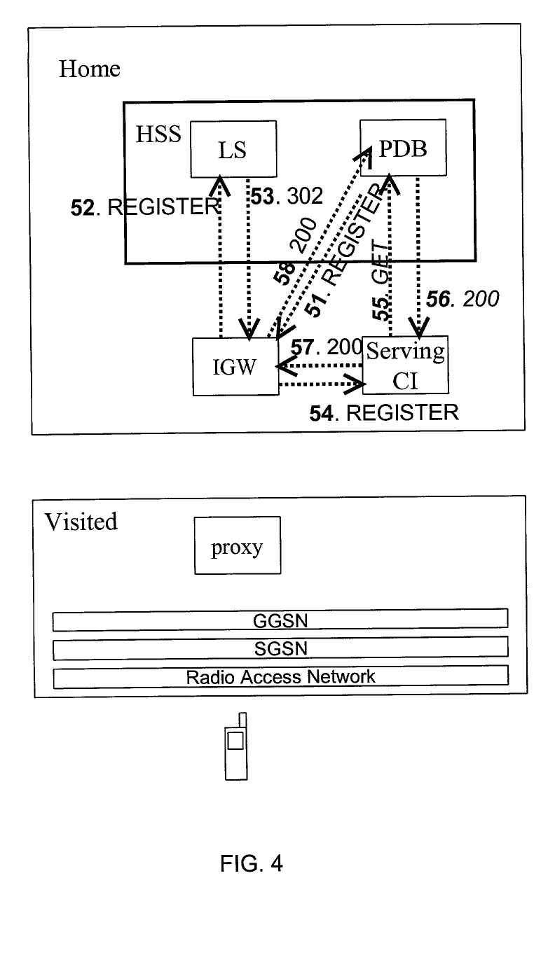

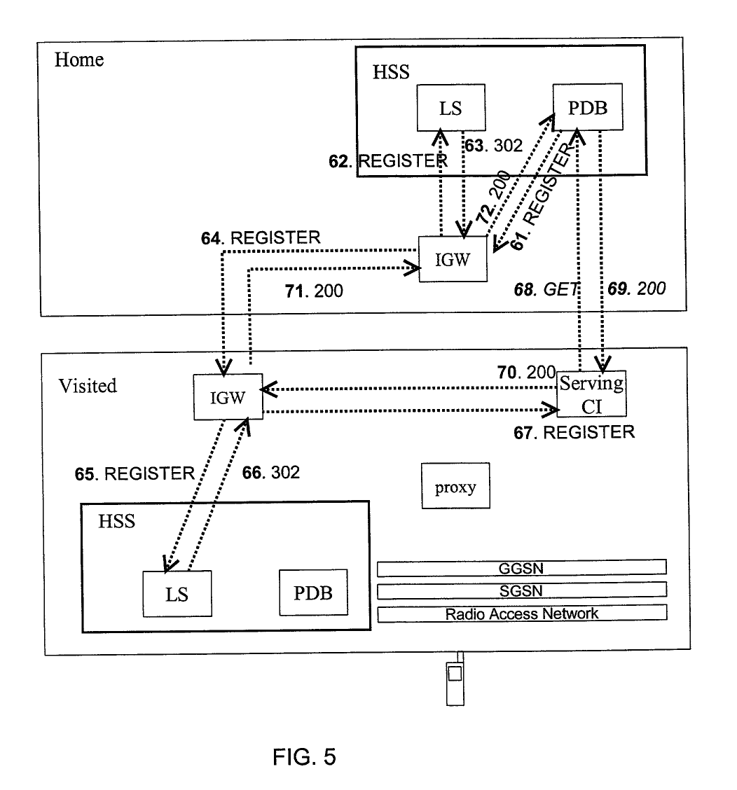

As defined in SIP, user agents must update their service parameters. In order for these changes to become effective in real-time, a mechanism is needed by which the home domain can update information in the call instance host, regardless of its location. A mechanism to perform this update is described below according to embodiments of the present invention with reference to FIGS. 4 and 5.

Since SIP allows for third-party registration, the mechanism for updating the user's service profile information requires no additional extensions to the SIP protocol. The message flows are similar to those described above, with two exceptions: the REGISTER request is generated by the HSS (via thePDB), and the proxy in the visited domain, or the user's terminal, is never involved. Involving the proxy is unnecessary, since it is unaffected by the service profile updates, and will continue to receive periodic REGISTER refreshes from the handset as described above.

The user's handset, and the proxy server to which the handset communicates (and the interposed network elements), is advantageously removed from the user service profile update procedure. The user service profile update is instead performed by a third party node in the network that has knowledge that the user profile has been updated. In the exemplary embodiments herein, the PDB in the HSS performs this function. However, in practice, any node with knowledge that the profile is in need of updating can perform this function.

More Particularly, third-party SIP registration messages are used to trigger profile refreshing. In the exemplary embodiments, a CI Host is located and used to download a new user service profile.

FIGS. 4 and 5 are block diagrams illustrating the call flow procedure for updating subscriber information using SIP third-party registration mechanisms according to embodiments of the present invention. Referring to FIG. 4, the HSS, via the PDB, performs a registration request with the IGW (51).

REGISTER sip:home-domain.com SIP/2.0

To: <sip:user@home-domain.com>

From: <sip:user@home-domain.com>;tag=0000-1111

Call-ID: 8888@handset1234.visited-domain.com

CSeq: 99 REGISTER

Supported: org.3gpp.service-transfer

Expires: 7200

The home IGW proxies the registration to the HSS/LS (52).

REGISTER sip:hss.home-domain.com SIP/2.0

To: <sip:user@home-domain.com>

From: <sip:user@home-domain.com>;tag=0000-1111

Call-ID: 8888@handset1234.visited-domain.com

CSeq: 99 REGISTER

Supported: org.3gpp.service-transfer

Expires: 7200

The HSS/LS selects a CI host for the user and redirects the IGW to the CI host when queried by the CI host (steps 52 and 53). The HSS/LS also indicates the location from which the service profile should be retrieved. The service-transfer extension is changed from “supported” to “require.” The LS further inserts a “Service-Transfer-Location” header to indicate in which domain the service is to be executed. Alternatively, another node (e.g., a third party node) with knowledge that the user's profile needs updating can be queried to supply this information, such as an O&M (operation and maintenance) system or an IVR (interactive voice response) system used for self administration of profiles.

SIP/2.0 302 Redirect

To: <sip:user@home-domain.com>;tag=5555-1212

From: <sip:user@home-domain.com>;tag=0000-1111

Call-ID: 8888@handset1234.visited-domain.com

Contact: sip:ci.home-domain.com

CSeq: 99 REGISTER

Require: org.3gpp.service-transfer

Service-Transfer-Location: home

Content-Type: text/uri-list

Content-length: 60

http://hss.home-domain.com/profiles/user%40home-domain.com

Based on the “Service-Transfer-Location” value of “home”, the IGW resends the REGISTER message to the machine indicated in the “Contact” header, which is the CI host (54).

REGISTER sip:ci.home-domain.com SIP/2.0

To: <sip:user@home-domain.com>

From: <sip:user@home-domain.com>;tag=0000-1111

Call-ID: 8888@handset1234.visited-domain.com

CSeq: 99 REGISTER

Contact: sip:user@proxy.visited-domain.com

Expires: 7200

Require: org.3gpp.service-transfer

Content-Type: text/uri-list

Content-Length: 60

http://hss. home-domain.com/profiles/user%40home-domain.com

The CI host will update the call instance record and refresh the subscriber information with information retrieved from the URL passed in the REGISTER message. To retrieve the information, a HTTP GET command is issued (55):

GET /profiles/user%40home-domain.com HTTP/1.1

User-Agent: EriCSCF/1.0

Host: hss:home-domain.com

Connection: close

Accept: text/xml

The HSS replies with the user's service profile, expressed in XML, for example (56). Note that the XML DTD shown here is merely demonstrative, and is not the only format available. Two exemplary formats are shown below: shown first is a service-oriented profile, followed by a trigger-oriented profile.

HTTP/1.1 200 OK

Server: Stronghold/2.4.2 Apache/1.3.6 C2NetEU/2410 (Unix)

Content-Type: text/xml;charset=“utf-8”

Last-Modified: Tue, 30 May 2000 02:17:24 GMT

Date: Tue, 30 May 2000 12:38:21 GMT

<?xml“version=“1.0” encoding=“utf-8”?>

<!DOCTYPE service-profile SYSTEM “3gsvcprof.dtd”>

<profile>

<service name=“call forward unconditional”>

<param name=“active”>false</param>

</service>

<service name=“call forward on busy”>

<param name=“active”>true</param>

<param name=“destination”>+19725830000</param>

</service>

</profile >

### (OR)

HTTP /1. 1 200 OK

Server: Stronghold/2.4.2 Apache /1.3.6 C2NetEU /2410 (Unix)

Content-Type: text/xml;charset=“utf-8”

Last-Modified: Tue, 30 May 2000 02:17:24 GMT

Date: Tue, 30 May 2000 12:38:21 GMT

<?xml version=“1.0” encoding=“utf-8”?>

<!DOCTYPE trigger-profile SYSTEM “3gtrgprof.dtd”>

<profile>

<trigger method=“INVITE” type=request direction=sent>

<trigger method=“INVITE” type=response from=100 to=199 direction=received />

<trigger method=“INVITE” type=response from=200 to=699 direction=sent />

<trigger method=“BYE” type=response from=200 to=699 direction=sent />

<trigger method=“BYE” type=response from=200 to=699 direction=received />

</profile>

In this example, the home network has a policy that registrations may be for no longer than 30 minutes (1800 seconds). The CI host adjusts the Expires header accordingly, and generates a response (57).

SIP /2.0: 00 OK

To: <sip: user@home-domain.com>;tag=AAAA-5309

From: sip: user@home-domain.com>;tag=0000-1111

Call-ID: 8888@handset1234.visited-domain.com

Cseq: 99 REGISTER

Expires: 1800

The home domain IGW forwards the response to the HSS (PDB) using normal SIP response handling rules (58).

Note that “HEAD/200/GET/200” sequence may be used in step 55 where the “GET/200” sequence is shown, when profile caching is used.

FIG. 5 is a block diagram illustrating the call flow procedure for updating subscriber information using SIP third-party registration mechanisms according to embodiments of the present invention using a visited execution registration and profile transfer. The execution of this procedure is fundamentally the same as described above with reference to FIG. 4, with the primary difference being the nature of the response from the home domain HSS/LS, or other node aware of the need for an update, when queried. Instead of redirecting the IGW to a selected CI host in the home domain, it redirects to an IGW in the visited domain (64).

Using normal registration handling, the visited domain IGW then queries the visited HSS (65) to determine which host to contact as the CI host. This information is returned in a SIP 302 response, which the CI host indicated in the “Contact” header (66). Based on this information, the IGW contacts the CI host (67). As described above, this CI host issues a HTTP GET to the URI passed in the SIP REGISTER request, which points to the user's service information (68). The service profile is then returned to the CI host (69), who then responds to the SIP register using normal response handling (steps 70 through 72).

The present invention addresses many of the needs within the 3GPP registration, service information transfer, and control selection areas with minimal impacts to the current SIP and SIP- related standards track documents in the IETF. Further, the extensions described are generally applicable, making their adoption within the IETF likely.

It will be appreciated that the steps of the methods illustrated above may be readily implemented either by software that is executed by a suitable processor or by hardware, such as an application-specific integrated circuit (ASIC).

Although described with reference to a communication system, it will be appreciated by those of ordinary skill in the art that this invention can be embodied in other specific forms without departing from its essential character. For example, the invention may be used in any multi-processor system. The embodiments described above should therefore be considered in all respects to be illustrative and not restrictive.

The various aspects of the invention have been described in connection with a number of exemplary embodiments. To facilitate an understanding of the invention, many aspects of the invention were described in terms of sequences of actions that may be performed by elements of a computer system. For example, it will be recognized that in each of the embodiments, the various actions could be performed by specialized circuits (e.g., discrete logic gates interconnected to perform a specialized function), by program instructions being executed by one or more processors, or by a combination of both.

Moreover, the invention can additionally be considered to be embodied entirely within any form of computer readable storage medium having stored therein an appropriate set of computer instructions that would cause a processor to carry out the techniques described herein. Thus, the various aspects of the invention may be embodied in many different forms, and all such forms are contemplated to be within the scope of the invention. For each of the various aspects of the invention, any such form of embodiment may be referred to herein as “logic configured to” perform a described action, or alternatively as “logic that” performs a described action.

It should be emphasized that the terms “comprises” and “comprising”, when used in this specification as well as the claims, are taken to specify the presence of stated features, steps or components; but the use of these terms does not preclude the presence or addition of one or more other features, steps, components or groups thereof.

Various embodiments of Applicants' invention have been described, but it will be appreciated by those of ordinary skill in this art that these embodiments are merely illustrative and that many other embodiments are possible. The intended scope of the invention is set forth by the following claims, rather than the preceding description, and all variations that fall within the scope of the claims are intended to be embraced therein.

What is claimed is:

1. A method of updating a user's service profile information in a home domain of a packet data network using Session Initiation Protocol (SIP), said method comprising the steps of:
updating an established user's service profile record in a call instance host associated with a user's terminal by retrieving the user's service profile information from a home subscriber server (HSS) of the home domain, said updating initiated by a REGISTER message, which contains sufficient information to identify the user's service profile, sent by a node in the system aware of a user profile change to the associated call instance host.

2. The method of claim 1, wherein the call instance host's retrieval of the user's service profile includes the steps of:
issuing a HTTP message to the HSS by the associated call instance host; and
receiving in response to the HTTP message, at the call instance host from the HSS, the user's service profile information in a response message.

3. The method of claim 2, wherein the response message is in an XML DTD service-oriented profile.

4. The method of claim 2, wherein the response message is in an XML DTD trigger-oriented profile.

5. The method of claim 2, wherein the response message is in an executable code format.

6. The method of claim 2, wherein the HTTP message includes one of a HTTP GET command or a HTTP HEAD command.

7. The method of claim 1, wherein the node in the system aware of the user profile change is one of the HSS or an operation and maintenance system in the network.

8. The method of claim 1, including the preliminary steps of:
registering the HSS of the home domain on an associated interrogating gateway;
querying the HSS by the associated interrogating gateway to determine the call instance host associated with the user; and
redirecting the associated interrogating gateway to the associated call instance host according to a response to the query.

9. The method of claim 8, wherein the step of querying the HSS by the associated interrogating gateway includes the step of sending an SIP message by the HSS to the interrogating gateway, said message including a Service-Transfer-Location header indicating in which domain a service is to be executed and a Contact header indicating the call instance host.

10. A method of updating a user's service profile information in a visited domain of a packet data network using SIP, said method comprising the steps of:
updating an established user's service profile record in a call instance host of the visited domain associated with a user's terminal by retrieving the user's service profile information from a HSS of the home domain, said updating initiated by a REGISTER message, which contains sufficient information to identify the user's service profile, sent by a node in the system aware of a user profile change to the associated visited domain call instance host.

11. The method of claim 10, wherein the call instance host retrieval of the user's service profile includes the steps of:
issuing a HTTP message to the home domain HSS by the associated call instance host; and
receiving in response to the HTTP message, at the associated call instance host from the home domain HSS, the user's service profile information in a response message.

12. The method of claim 11, wherein the response message is in an XML DTD service-oriented profile.

13. The method of claim 11, wherein the response message is in an XML DTD trigger-oriented profile.

14. The method of claim 11, wherein the response message is in an executable code format.

15. The method of claim 11, wherein the HTTP message includes one of a HTTP GET command or a HTTP HEAD command.

16. The method of claim 10, wherein the node in the system aware of the user profile change is one of the visited domain HSS or an operation and maintenance system in the network.

17. The method of claim 10, including the preliminary steps of:
registering the home domain HSS on an associated home domain interrogating gateway;
querying the home domain HSS by the home domain interrogating gateway to determine an associated visited domain interrogating gateway;
redirecting the associated home domain interrogating gateway to the associated visited domain interrogating gateway according to a response to the home domain HSS query;
querying a visited domain HSS by the associated visited domain interrogating gateway to determine the associated call instance host in the visited domain; and
redirecting the associated visited domain interrogating gateway to the associated call instance host according to a response to the visited domain HSS query.

18. The method of claim 17, wherein the steps of querying the home domain and visited domain HSS by the respective associated interrogating gateways each include the step of sending an SIP message by the respective HSS to the respective associated interrogating gateway, said message including a Service-Transfer-Location header indicating in which domain a service is to be executed and, in the case of the visited domain HSS, a Contact header indicating the call instance host.

19. A system for updating a user's service profile information in a home domain in a packet data network using SIP, said system including a HSS and a call instance host, the system further comprising:
logic that updates an established user's service profile record in the call instance host by retrieving the user's service profile information from the HSS, said updating initiated by a REGISTER message, which contains sufficient information to identify the user's service profile, sent by a node in the system aware of a user profile change to the call instance host.

20. The system of claim 19, wherein the node in the system aware of the user profile change is one of the HSS or an operation and maintenance system in the network.

21. The system of claim 19, wherein, for the retrieval of the user's service profile, the call instance host comprises:
logic that issues a HTTP message by the call instance host to the HSS;
logic that receives in response to the HTTP message, from the HSS, the user's service profile in a response message; and
storage means that stores the user's service profile information.

22. The system of claim 19, further including an interrogating gateway and additionally comprising:
logic that registers the HSS on the interrogating gateway;
logic that queries the HSS by the interrogating gateway to determine the call instance host associated with the user; and
logic that redirects the interrogating gateway to the associated call instance host according to a response to the query.

23. A system for updating a user's service profile information in a visited domain in a packet data network using SIP, said system including a home domain HSS, a visited domain HSS and a visited domain call instance host, the system further comprising:
logic that updates an established user's service profile record in the visited domain call instance host by retrieving the user's service profile information from the home domain HSS, said updating initiated by a REGISTER message, which contains sufficient information to identify the user's service profile, sent by a node in the system aware of a user profile change to the visited domain call instance host.

24. The system of claim 23, wherein the node in the system aware of the user profile change is one of the visited domain HSS or an operation and maintenance system in the network.

25. The system of claim 23, wherein, for the retrieval of the user's service profile, the visited domain call instance host comprises:
logic that issues a HTTP message by the visited domain call instance host to the home domain HSS;
logic that receives in response to the HTTP message, from the home domain HSS, the user's service profile in a response message; and
storage means in the home domain HSS that stores the user's service profile information.

26. The system of claim 23, further including a home domain interrogating gateway and a visited domain interrogating gateway and additionally comprising:
logic that registers the home domain HSS on the visited domain interrogating gateway;
logic that queries the visited domain HSS by the visited domain interrogating gateway to determine the visited domain call instance host; and
logic that redirects the visited domain interrogating gateway to the visited domain call instance host according to a response to the query.

27. The system of claim 23, further including a home domain interrogating gateway and a visited domain interrogating gateway, wherein the REGISTER message is sent via the visited domain interrogating gateway, said visited domain interrogating gateway identified by the home domain HSS via the home domain interrogating gateway.
